(19) United States
(12) Patent Application Publication
(10) Pub. No.: US 2026/0098601 A1
(43) Pub. Date: Apr. 9, 2026

(54) SYSTEM AND METHOD FOR TIGHT FITTING PLASTIC LINERS IN PIPELINE SECTIONS USING PRESTRESSING ELEMENTS

(71) Applicant: SAUDI ARABIAN OIL COMPANY, Dhahran (SA)

(72) Inventors: Thibault Villette, Belfort (FR); Abderrazak Traidia, Lussan (FR); Anwar Parvez, Jebel Heights (SA); Abdulaziz Asiri, Dhahran (SA)

(73) Assignee: SAUDI ARABIAN OIL COMPANY, Dhahran (SA)

(21) Appl. No.: 18/905,319

(22) Filed: Oct. 3, 2024

(51) Int. Cl. F16L 55/165

(52) U.S. Cl. CPC F16L 55/1652

(57) ABSTRACT

A method that includes providing a liner including a liner first outer diameter, disposing the liner inside a coil, applying to the liner, using the coil, a radial compression prestress to reduce the liner first outer diameter to a liner second outer diameter, and removing the radial compression prestress thereby expanding the liner from the liner second outer diameter to form a surface-surface contact between the liner and a pipe inner diameter of a pipe.

### BACKGROUND

Lining techniques are used to rehabilitate lengths of pipeline which have deteriorated to a point where leakage or structural instability has become an issue mainly in water, sewer, culverts, and gas networks. Lining techniques are also used on new pipelines (before installation) to extend pipeline life cycle by providing protection against corrosion.

Lining techniques are available for a wide range of diameters, from as little as 50 millimeters (mm)/2 inches up to around 3 meters (m)/10 feet, although a small amount of lining over 3 meters has been undertaken, depending on the system being utilized. Most, if not all, pipe materials now available have lining techniques that will suit including asbestos cement, clayware, brick, concrete, GRP, metallic pipes, and polymer pipes.

The main lining techniques are summarized below.

### Cured in Place Pipe (CIPP) Lining

CIPP Lining includes a lining tube saturated with resin that is installed in a pipeline. CIPP lining may be applied as a structural or non-structural solution. A winch may be employed to install the liner in an uninflated condition through the host pipe. The liner may be inverted through the host pipe and may use air or water pressure, a scaffold, and/or an inversion drum. Following installation of the liner in the pipe, the liner is inflated, e.g., by the air pressure, the water pressure, and/or the inversion medium. The liner is maintained under pressure and the resin is cured (e.g., hardened) thereby joining the liner to the host pipe. Curing processes include ambient cure, hot water cure, steam cure, UV light cure, high intensity light cure, etc. Curing processes may be tailored for the applications, e.g., an ambient cure for smaller diameters and a hot cure for larger diameters.

### Epoxy Resin Lining Systems

Epoxy Resin Lining of pipes includes applying a thin lining of resin (typically 1 mm/0.040 inches thick) to a thoroughly cleaned and prepared surface. This technique may isolate the host pipe from the conveyed medium. In man-entry sized pipe the application is usually achieved by hand-held spray guns. In non-man-entry pipe sizes, remotely controlled spray systems may be utilized. Although some structural reinforcement is achieved, there is, however, a question over the status of this type of renovation as a structural option.

### PU Lining Systems

PU (Polyurethane) linings may improve flow characteristics of the host pipe and protect against or prevent further corrosion. PU linings are applied to prepared surfaces. PU linings may eliminate or prevent further corrosion by forming an impermeable barrier between the flow within the pipe and the inner pipe surface. Thicker coatings may offer some structural reinforcement. For small diameter pipes (non-man-entry), a thin layer of PU material is sprayed on using a high-speed rotating nozzle and for man-entry sized pipe the PU is applied using hand-held spray guns.

### Cement Mortar Lining

Cement Mortar Lining (CML) is the application of a cement mortar (typically about 4 mm/0.16 inches thick) to the inside of pipelines to protect against corrosion. Typically, CML is applied to a prepared surface using a remotely controlled spray head or is hand sprayed in man-entry sizes and for smaller areas/lengths of pipe.

### Sliplining

Sliplining includes continuous or discreet pipes being inserted within existing, prepared (host) pipes. Long lengths of PE pipes may be pulled in within water mains. Individual PE pipes may be inserted in sewers. This generally reduces the original bore of the pipe, but friction reduction may negate the loss of cross-sectional area regarding the flow properties. Slip lining material includes plastics such as polyethylene (PE) or polyvinyl chloride (PVC). Slip lining material includes concrete, composite, graphite reinforced plastic (GRP), or clayware pipes. Sliplining may form an annulus between liner pipe and host pipe and the annulus may be grouted to create a composite of host and lined pipe.

### Folded Pipe Systems

Folded Liner Pipe (FLP) Systems include a liner pipe external diameter manufactured to the same internal diameter of the host pipe being lined. Folded Pipe liners may be folded into a ‘C’ or ‘U’ shape and held in this shape, e.g., cold factory folded, hot factory folded, and site folded. In some FLP systems straps are used to hold the shape in a size that will allow it to be installed in the host pipe. Air, water, or steam pressure is applied to inside of the liner to cause the holding straps to break or, in the case of hot folded, the pressure plus the heat is used to revert the liner to its original shape and diameter. The round pipe is then Pulled/Pushed through a die on site to create the required fold. Holding straps are placed on the liner and it is usually then Pulled/Pushed directly into the host pipe as a single operation.

### Concentric Pipe Reduction Systems

Concentric Pipe Reduction (CPR) Systems form a tight fit lining system within a host pipe by having the liner pipe diameter reduced to a size that will allow it to be pulled or pushed into the host pipe. The liner expands to its original diameter thereby pushing it against the host pipe inner wall. The liner pipe diameter may be reduced using tension reduction by pulling the liner through a reduction die (e.g., Swage lining) and/or using external compression (e.g., Rolldown) by pushing the pipe through a set of rollers. In swage lining, with the liner pipe in place in the host pipe, the tension on the liner pipe is released to allow the pipe to revert to its original diameter. In rolldown, the liner is pulled through the host pipe and internal pressure is applied to the liner to revert it to its original size.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

This disclosure presents, in accordance with one or more embodiments, a method that includes providing a liner including a liner first outer diameter, disposing the liner inside a coil, applying to the liner, using the coil, a radial compression prestress to reduce the liner first outer diameter to a liner second outer diameter, and removing the radial compression prestress thereby expanding the liner from the liner second outer diameter to form a surface-surface contact between the liner and a pipe inner diameter of a pipe.

This disclosure presents, in accordance with one or more embodiments, a system that includes a liner, including a liner first outer diameter, disposed in a coil. The coil is configured to apply to the liner a radial compression prestress to reduce the liner first outer diameter to a liner second outer diameter. The system includes a pipe including a pipe inner diameter. Removing the radial compression prestress expands the liner from the liner second outer diameter to form a surface-surface contact between the liner and the pipe inner diameter.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a schematic diagram in accordance with one or more embodiments.

FIG. 2 shows a schematic diagram in accordance with one or more embodiments.

FIG. 3 shows a flowchart in accordance with one or more embodiments.

FIG. 4 shows a schematic diagram in accordance with one or more embodiments.

FIG. 5 shows a schematic diagram in accordance with one or more embodiments.

FIG. 6 shows a schematic diagram in accordance with one or more embodiments.

FIG. 7 shows a schematic diagram in accordance with one or more embodiments.

FIG. 8 shows a schematic diagram in accordance with one or more embodiments.

FIG. 9 shows a schematic diagram in accordance with one or more embodiments.

FIG. 10 shows a schematic diagram in accordance with one or more embodiments.

FIG. 11 shows a schematic diagram in accordance with one or more embodiments.

FIG. 12 shows a schematic diagram in accordance with one or more embodiments.

FIG. 13 is a block diagram of a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Regarding the figures described herein, when using the term “down” the direction is toward or at the bottom of a respective figure and “up” is toward or at the top of the respective figure. “Up” and “down” are oriented relative to a local vertical direction. However, in the oil and gas industry, one or more activities take place in a vertical, substantially vertical, deviated, substantially horizontal, or horizontal well. Therefore, one or more figures may represent an activity in deviated or horizontal wellbore configuration. “Uphole” may refer to objects, units, or processes that are positioned relatively closer to the surface entry in a wellbore than another. “Downhole” may refer to objects, units, or processes that are positioned relatively farther from the surface entry in a wellbore than another. Measured depth (MD) is the length measured along the well trajectory from the surface, or a designated position above the surface, to a location in the well. True vertical depth (TVD) is the vertical distance from a point in the well at a location of interest to a reference point on the surface.

Some embodiments of the invention relate an alternative system for the tight fitting of polymer liner in a pipe or pipeline section based on a prestressed coil in a helical form, i.e., a helical coil.

The polymer liner includes helical grooves on its outside surface that allow positioning the liner inside a large diameter coil that has been put under compression. When stress-free, the outside diameter of the coil is smaller than the internal diameter of the (to be lined) host pipe section, while the outside diameter of the liner is larger. Once the liner is inserted into the prestressed coil, the coil compression is progressively released, which results in an elongation and more importantly a diameter reduction of the liner to be below that of the pipe section. The prestressed liner-coil system is then inserted inside the host pipe section. The last step of the lining process consists of tight-fitting the liner to the pipe section by pulling out the coil to release the prestress on the liner outer diameter.

Advantages of embodiments of the invention are presented below. Some embodiments of the prestressed liner fitting include, in contrast to some lining techniques that utilize plastic or thermoplastic deformation in the polymer liner (example swage-lining), only elastic (and reversible) deformation is involved. This is due to the fact that tensile stresses applied to the liner are uniformly distributed along the liner, contrary to other techniques where high stresses are applied locally. This characteristic limits the risks of damaging the liner during its installation and tends to result in higher durability to the liner while preserving its structural properties and preventing against collapse.

In some embodiments, the helical grooves remain after removing the coil, which offers at least two advantages: the grooves provide space to capture permeated gases and direct the gases to a venting point in view of mitigating risks of liner collapse in case of rapid gas decompression; and the grooves can be used for instrumenting the pipeline (insertion of electrical cables, optical fiber, etc.) In some embodiments, the required equipment for implementation is low-tech, and the calculations are simple to achieve the right coil design compatible with the designated liner. In some embodiments, the system may include a control system with an algorithm that uses advanced computational techniques for determining optimum coil sizes, coil wire diameters, liner material, liner inner diameter, liner outer diameter, etc., and may learn from past outcomes using predetermined inputs.

Some embodiments of the invention belong to the lining technique category called Concentric Liner Reduction Systems. The described technique may be suitable for short liner sections due to the fact the whole liner section is prestressed before being pulled into the host pipe. This makes it particularly suitable for lining of large diameter host pipes.

The introduction of helical grooved channels on the outer side of the liner means that excess material is used during the production of the non-grooved liner. Depending on design standards, minimum liner thickness to avoid collapse usually does not include the thickness of the groove. Lined pipe may be used in water, sewer, and culverts. Lined pipe may be used in petroleum oil and gas networks such as those described below.

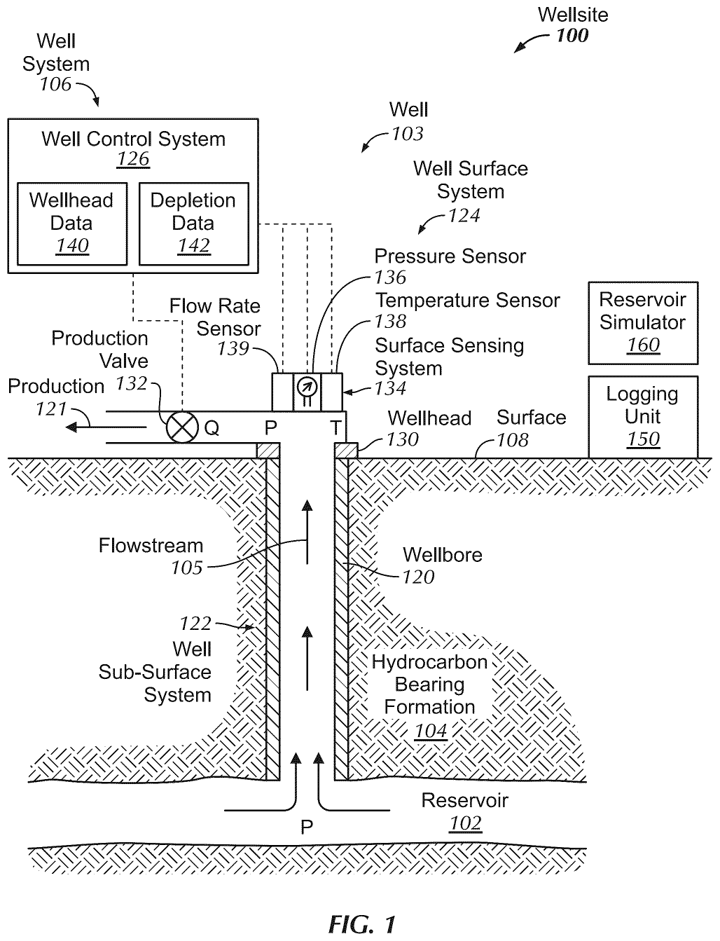

Turning to FIG. 1, FIG. 1 shows a schematic diagram in accordance with one or more embodiments. As shown FIG. 1 illustrates a well environment 100 with a wellsite 101 that includes a well 103, a hydrocarbon reservoir (a reservoir 102) located subsurface in a hydrocarbon-bearing formation 104, and a well system 106. The hydrocarbon-bearing formation 104 may include a porous or fractured rock formation that resides underground, beneath the surface 108 of the earth. In the case of the well system 106 being a hydrocarbon well, the reservoir 102 may include a portion of the hydrocarbon-bearing formation 104. The hydrocarbon-bearing formation 104 and the reservoir 102 may include different layers of rock having varying characteristics, such as varying degrees of permeability, porosity, and resistivity. In the case of the well system 106 being operated as a production well, the well system 106 may facilitate the extraction of hydrocarbons (known as production) from the reservoir 102.

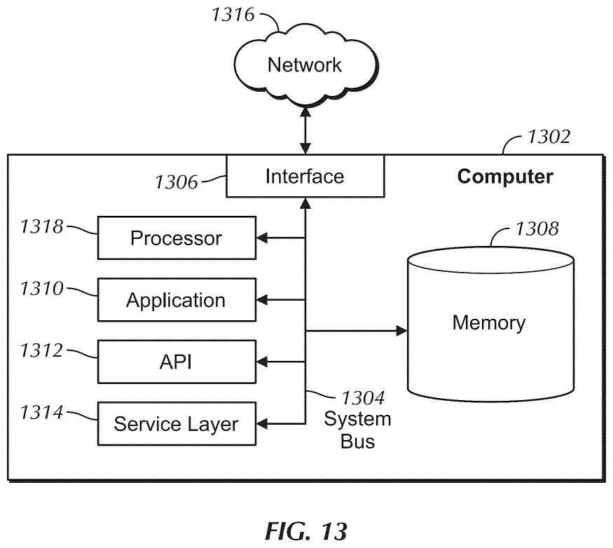

In some embodiments, the well system 106 includes a wellbore 120, a well sub-surface system 122, a well surface system 124, and a control system 126 for the well. The control system 126 may control various operations of the well system 106, such as well production operations, well completion operations, well maintenance operations, and reservoir monitoring, assessment, and development operations. In some embodiments, the control system 126 includes a computer system that is the same as or similar to the computer system (a computer 1302) described below in FIG. 13 and the accompanying description.

The wellbore 120 may include a bored hole that extends from the surface 108 into a target zone of the hydrocarbon-bearing formation 104, such as the reservoir 102. An upper end of the wellbore 120, terminating at or near the surface 108 near the uphole end of the wellbore 120, and a lower end of the wellbore, terminating in the hydrocarbon-bearing formation 104 near the downhole end of the wellbore 120. The wellbore 120 may facilitate the circulation of drilling fluids during drilling operations, the flow (a flowstream 105) of hydrocarbon production (production 121) (e.g., oil and gas) from the reservoir 102 to the surface 108 during production operations, the injection of substances (e.g., water) into the hydrocarbon-bearing formation 104 or the reservoir 102 during injection operations, or the communication of monitoring devices (e.g., logging tools) into the hydrocarbon-bearing formation 104 or the reservoir 102 during monitoring operations (e.g., during in situ logging operations).

In some embodiments, during operation of the well system 106, the control system 126 collects and records wellhead data 140 and depletion data 142 for the well system 106. The wellhead data 140 may include, for example, a record of measurements of wellhead pressure (P) (e.g., including flowing wellhead pressure (FWHP)), wellhead temperature (T) (e.g., including flowing wellhead temperature), wellhead production rate (Q) over some or all of the life of the well system 106, and water cut data. In some embodiments, the measurements are recorded in real-time, and are available for review or use within seconds, minutes or hours of the condition being sensed (e.g., the measurements are available within 1 hour of the condition being sensed). In such an embodiment, the wellhead data 140 may be referred to as real-time wellhead data. Real-time wellhead data may enable an operator of the well system 106 to assess a relatively current state of the well system 106 and make real-time decisions regarding development of the well system 106 and the reservoir 102, such as on-demand adjustments in regulation of production flow from the well.

With respect to water cut data, the well system 106 may include one or more water cut sensors. For example, a water cut sensor may be hardware and/or software with functionality for determining the water content in oil, also referred to as “water cut.” Measurements from a water cut sensor may be referred to as water cut data and may describe the ratio of water produced from the wellbore 120 compared to the total volume of liquids produced from the wellbore 120. Water cut sensors may implement various water cut measuring techniques, such as those based on capacitance measurements, Coriolis effect, infrared (IR) spectroscopy, gamma ray spectroscopy, and microwave technology. Water cut data is obtained during production operations to determine various fluid rates found in production from the well system 106. This water cut data is used to determine water-to-gas information regarding the wellhead 130.

In some embodiments, a water-to-gas ratio (WGR) is determined using a multiphase flow meter. For example, a multiphase flow meter may use magnetic resonance information to determine the number of hydrogen atoms in a particular fluid flow. As oil, gas, and water all contain hydrogen atoms, a multiphase flow may be measured using magnetic resonance. In particular, a fluid may be magnetized and subsequently excited by radio frequency pulses. The hydrogen atoms may respond to the pulses and emit echoes that are subsequently recorded and analyzed by the multiphase flow meter.

In some embodiments, the well surface system 124 includes a wellhead 130. The wellhead 130 may include a rigid structure installed at the uphole end of the wellbore 120, at or near where the wellbore 120 terminates at the surface 108 of the Earth. The wellhead 130 may include structures for supporting (or hanging) casing and production tubing extending into the wellbore 120. Production 121 may flow through the wellhead 130, after exiting the wellbore 120 and the well sub-surface system 122, including, for example, the casing and the production tubing. In some embodiments, the well surface system 124 includes flow regulating devices that are operable to control the flow of substances into and out of the wellbore 120. For example, the well surface system 124 may include one or more of a production valve 132 that are operable to control the flow of production 121. For example, a production valve 132 may be fully opened to enable unrestricted flow of production 121 from the wellbore 120, the production valve 132 may be partially opened to partially restrict (or throttle) the flow of production 121 from the wellbore 120, and production valve 132 may be fully closed to fully restrict (or block) the flow of production 121 from the wellbore 120, and through the well surface system 124.

Keeping with FIG. 1, in some embodiments, the well surface system 124 includes a surface sensing system 134. The surface sensing system 134 may include sensors for sensing characteristics of substances, including production 121, passing through or otherwise located in the well surface system 124. The characteristics may include, for example, pressure, temperature, and flow rate of production 121 flowing through the wellhead 130, or other conduits of the well surface system 124, after exiting the wellbore 120.

In some embodiments, the surface sensing system 134 includes a surface pressure sensor 136 operable to sense the pressure of production 121 flowing through the well surface system 124, after it exits the wellbore 120. The surface pressure sensor 136 may include, for example, a wellhead pressure sensor that senses a pressure of production 121 flowing through or otherwise located in the wellhead 130. In some embodiments, the surface sensing system 134 includes a surface temperature sensor 138 operable to sense the temperature of production 121 flowing through the well surface system 124, after it exits the wellbore 120. The surface temperature sensor 138 may include, for example, a wellhead temperature sensor that senses a temperature of production 121 flowing through or otherwise located in the wellhead 130, referred to as wellhead temperature (T). In some embodiments, the surface sensing system 134 includes a flow rate sensor 139 operable to sense the flow rate of production 121 flowing through the well surface system 124, after it exits the wellbore 120. The flow rate sensor 139 may include hardware that senses a flow rate of production 121 (Q) passing through the wellhead 130.

In some embodiments, the well system 106 includes a reservoir simulator 160. For example, the reservoir simulator 160 may include hardware and/or software with functionality for generating one or more reservoir models regarding the hydrocarbon-bearing formation 104 and/or performing one or more reservoir simulations. For example, the reservoir simulator 160 may store well logs and data regarding core samples for performing simulations. A reservoir simulator may further analyze the well log data, the core sample data, seismic data, and/or other types of data to generate and/or update the one or more reservoir models. While the reservoir simulator 160 is shown at a well site, embodiments are contemplated where reservoir simulators are located away from well sites. In some embodiments, the reservoir simulator 160 may include a computer system that is similar to the computer system (the computer 1302) described below with regard to FIG. 13 and the accompanying description.

In some embodiments, the well system 106 includes a logging unit 150. For example, the logging unit 150 may include hardware and/or software with functionality for generating one or more well logs regarding the hydrocarbon-bearing formation 104 and/or acquiring the data used in generating the well logs. The well logs may be acquired downhole within the wellbore 120 located within the reservoir 102 using the logging unit 150. The logging unit 150 may include, for example, an optical logging tool, an acoustic logging tool, and a resistivity logging tool. Thus, the well log acquired from the logging unit 150 may be an optical log, an acoustic log, or resistivity image log. In some embodiments, the logging unit 150 includes a computer system that is the same as or similar to that of the computer system (a computer 1302) described below in FIG. 13 and the accompanying description.

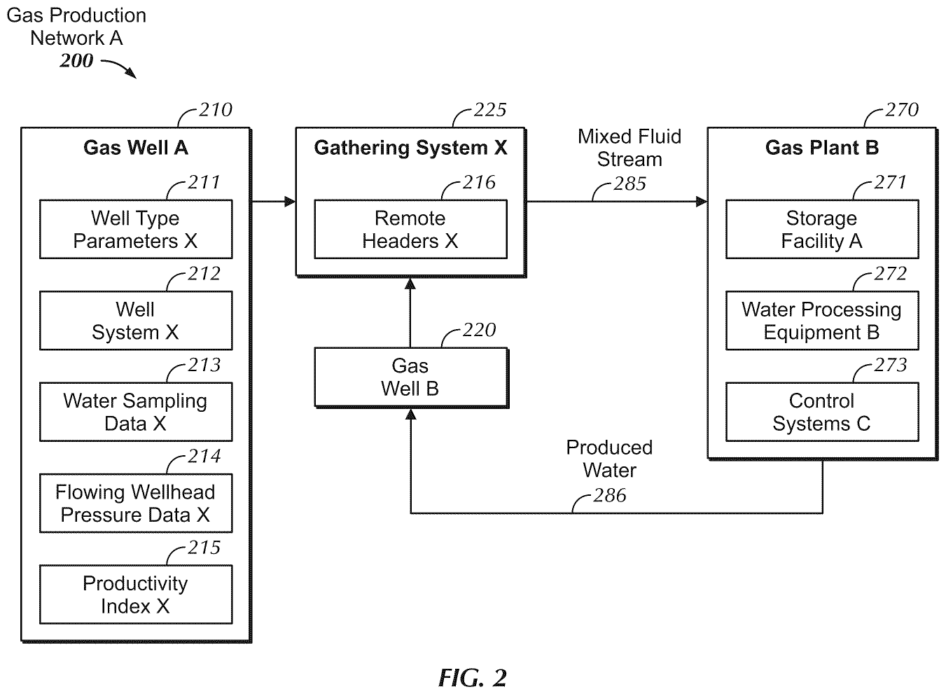

FIG. 2 shows a schematic diagram in accordance with one or more embodiments. FIG. 2 describes a gas production network, such as a network for produced natural gas. Although FIG. 2 is described and shown as a gas network, one of ordinary skill in the art will appreciate that the gas network may be any type of pipe and controls network without departing from the scope of embodiments disclosed herein. The gas network may contain gases, liquids, and solids (e.g., suspended solids) in any suitable combination. For example, the network described in FIG. 2 may be a water network, an oil network, a water-oil-gas network, a water-oil-gas-solids network, a chemical products network, etc., the pipeline transport of which may require lined pipe.

As shown in FIG. 2, a gas production network (e.g., gas production network A 200) may include various gas wells (e.g., gas well A 210, gas well B 220), various gas plants (e.g., gas plant B 270), various control systems (e.g., control systems C 273), various network elements (not shown), and/or a gas supply manager (not shown). A gas well may include a well system (e.g., well system X 212) that is similar to well system 106 described above in FIG. 1 and the accompanying description. In some embodiments, various types of gas well data are collected over the gas production network, such as water sampling data (e.g., water sampling data X 213), flowing wellhead pressure data (e.g., flowing wellhead pressure data X 214), productivity index information (e.g., productivity index X 215). Likewise, the gas production network may also collect various well type parameters (e.g., well type parameters X 211) that describe various gas well characteristics, such as reservoir type, completion type, and surface facility conditions.

In some embodiments, one or more gas wells are coupled to a gathering system (e.g., gathering system X 225). A gathering system (also referred to as a collecting system or gathering facility) may include various hardware arrangements that connect flowlines from several gas wells into a single gathering line. For example, a gathering system may include flowline networks, headers, pumping facilities, separators, emulsion treaters, compressors, dehydrators, tanks, valves, regulators, and/or associated equipment. In particular, a remote header (e.g., remote headers X 216) may have production valves and testing valves to control a mixed stream for a flowline of a respective gas well. Thus, a gathering system may direct various hydrocarbon fluids to a processing or testing facility, such as a gas plant. In some embodiments, a gathering system manages individual fluid ratios (e.g., a particular gas-to-water ratio or condensate-to-gas ratio) as well as supply rates of oil, gas, and water. For example, a gathering system may assign a particular production value or ratio value to a particular gas well by opening and closing selected valves among the remote headers and using individual metering equipment or separators. Furthermore, a gathering system may be a radial system or a trunk line system. A radial system brings various flowlines to a single central header. In contrast, a trunk-line system uses several remote headers to collect oil and gas from fields that cover a large geographic area. Once collected, the gathering system may transport and control the flow of oil or gas to a storage facility, a gas processing plant, or a shipping point.

Keeping with FIG. 2, gas is transported from one or more gas wells (e.g., gas well A 210) to one or more gas plants (e.g., gas plant B 270), such as through one or more mixed fluid streams (e.g., mixed fluid stream 285). More specifically, a gas plant may refer to various types of industrial plants such as a gas processing plant, a gas cycling plant, or a compressor plant. A gas processing plant (also referred to as a natural gas processing plant) is a facility that processes natural gas to recover natural gas liquids (e.g., condensate, natural gasoline, and liquefied petroleum gas) and sometimes other substances such as sulfur. A gas cycling plant may refer to an oilfield installation coupled to a gas-condensate reservoir.

In particular, a gas cycling plant may extract various liquids from natural gas. Consequently, the remaining dry gas may be compressed prior to return to a producing formation, e.g., to maintain reservoir pressure. Moreover, various components of natural gas may be classified according to their vapor pressures, such as low-pressure liquid (i.e., condensate), intermediate pressure liquid (i.e., natural gasoline), and high-pressure liquid (i.e., liquefied petroleum gas). Examples of natural gas liquids include propane, butane, pentane, hexane, and heptane. A compressor plant is a facility that includes multiple compressors, auxiliary treatment equipment, and pipeline installations for pumping natural gas over long distances. A compressor station may also repressurize gas in large gas pipelines or to link offshore gas fields to their final terminals.

Keeping with gas plants, a gas plant may include water processing equipment (e.g., water processing equipment B 272) that includes hardware and/or software for extracting, treating, and/or disposing of water associated with gas processing. More specifically, a gas plant may extract produced water (e.g., produced water 286) during the separation of oil or gas from a mixed fluid stream (e.g., mixed fluid stream 285) acquired from a gas well. This produced water is a kind of brackish and saline water brought to the surface from underground formations.

In particular, oil and gas reservoirs may have water in addition to hydrocarbons in various zones underneath the hydrocarbons, and even in the same zone as the oil and gas. However, most produced water is of very poor quality and may include poisonous gases such as dissolved hydrogen sulfide forming sulfuric acid, other gases such as dissolved carbon dioxide which may react with water to form carbonic acid, produced water may include high levels of natural salts and minerals that have dissociated from geological formations in the target reservoir. Likewise, produced water may also acquire dissolved constituents from fracturing fluids (e.g., substances added to the fracturing fluid to help prevent pipe corrosion, minimize friction, and aid the fracking process). However, through various water treatments, produced water may be reused in one or more gas wells, e.g., through waterflooding where produced water is injected into the reservoirs. By injecting produced water into an injection well, the injected water may force oil and gas to one or more production wells.

Keeping with produced water, a gas plant may use various treatment technologies in order to reuse or dispose of produced water, such as conventional treatments and advanced treatments. For example, conventional treatments may include flocculation, coagulation, sedimentation, filtration, and lime softening water treatment processes. Thus, conventional treatment processes may include functionality for removing suspended solids, oil and grease, hardness compounds, and other nondissolved water components. With advanced treatment technologies, water processing equipment may include functionality for performing reverse osmosis membranes, thermal distillation, evaporation and/or crystallization processes. These advanced treatment technologies may treat dissolved solids, such as chlorides, salts, barium, strontium, and sometimes dissolved radionuclides.

In some embodiments, produced water is sent to a wastewater treatment plant that is equipped to remove barium and strontium, e.g., using sulfate precipitation. Outside of treatments for reusing produced water, water processing equipment may dispose of produced water using various water management options. For example, produced water may be disposed in saltwater wells. Likewise, produced water may also be eliminated through a deep well injection.

In some embodiments, a gas plant may include one or more storage facilities (e.g., storage facility A 271) and one or more control systems (e.g., control systems C 273). For example, different forms of gas may be stored in various storage facilities that include surface containers as well as various underground reservoirs, such as depleted gas reservoirs, aquifer reservoirs, and salt cavern reservoirs. With respect to control systems, a control system may include hardware and/or software that monitors and/or operates equipment, such as at a gas well or in a gas plant.

Examples of control systems may include one or more of the following: an emergency shut down (ESD) system, a safety control system, a video management system (VMS), process analyzers, other industrial systems, etc. In particular, a control system may include a programmable logic controller that may control valve states, fluid levels, pipe pressures, warning alarms, pressure releases and/or various hardware components throughout a facility. Thus, a programmable logic controller may be a ruggedized computer system with functionality to withstand vibrations, extreme temperatures, wet conditions, and/or dusty conditions, such as those around a refinery or drilling rig.

With respect to distributed control systems, a distributed control system may be a computer system for managing various processes at a facility using multiple control loops. As such, a distributed control system may include various autonomous controllers (such as remote terminal units) positioned at different locations throughout the facility to manage operations and monitor processes. A distributed control system may include no single centralized computer for managing control loops and other operations. On the other hand, a SCADA system (supervisory control and data acquisition may include a control system that includes functionality for enabling monitoring and issuing of process commands through local control at a facility as well as remote control outside the facility. With respect to a remote terminal unit (RTU), an RTU may include hardware and/or software, such as a microprocessor, that connects sensors and/or actuators using network connections to perform various processes in the automation system.

Keeping with control systems, a control system may be coupled to facility equipment. Facility equipment may include various machinery such as one or more hardware components that may be monitored using one or more sensors. Examples of hardware components coupled to a control system may include crude oil preheaters, heat exchangers, pumps, valves, compressors, loading racks, and storage tanks among various other types of hardware components.

Hardware components may also include various network elements or control elements for implementing control systems, such as switches, routers, hubs, PLCs, remote terminal units, user equipment, or any other technical components for performing specialized processes. Examples of sensors may include pressure sensors, torque sensors, rotary switches, weight sensors, position sensors, microswitches, hydrophones, accelerometers, etc. A gas supply manager, user devices, and network elements may be computer systems similar to the computer system (the computer 1302) described in FIG. 13 and the accompanying description.

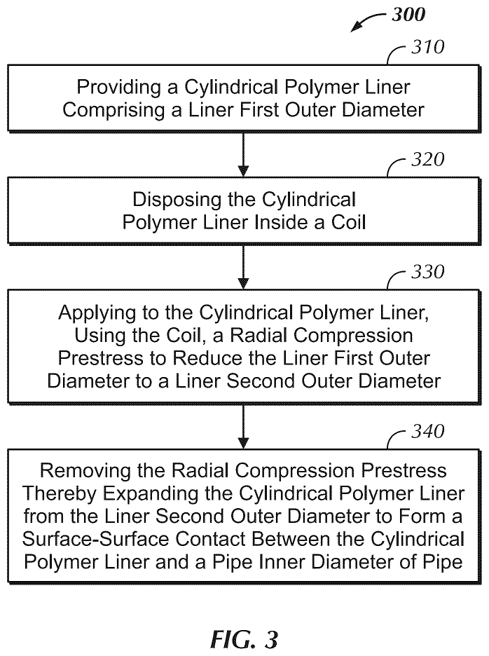

FIG. 3 shows a flowchart in accordance with one or more embodiments. FIG. 3 describes a general method (e.g., method 300) for tight-fitting plastic liners in pipeline sections using prestressing elements.

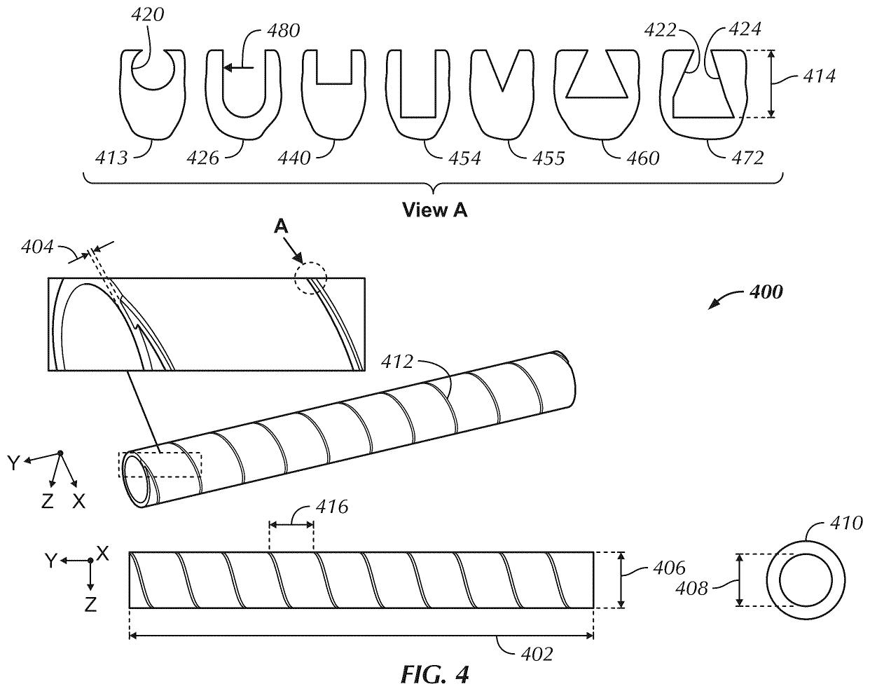

At step 310, the method includes providing a cylindrical polymer liner (e.g., a liner) comprising a liner first outer diameter. The cylindrical polymer liner (e.g., a liner CPL 400, FIG. 4) includes parameters of length Lr, thickness Tr, and outside diameter Dr. The liner first outer diameter is larger than the pipe inner diameter, i.e., the liner outside diameter (OD) Dr is specified to be larger than the internal diameter (ID) Dp of a host pipe section to be lined. The polymer liner section includes an external helical groove that has been molded, machined, or otherwise disposed on the outside diameter of the polymer liner. The helical groove includes a predetermined groove depth and a groove pitch.

At step 320, the method includes disposing the liner inside a coil. The external helical groove may have a helical groove pitch corresponding to a compressed coil pitch. In this manner the method includes engaging the coil in the external helical groove, i.e., the helix. The coil may include a coil first inner diameter that changes to a coil second diameter when the coil is compressed to form a compressed coil using a predetermined axial compressing force. The coil first inner diameter may be smaller than the liner first outer diameter and the coil second inner diameter may be larger than the liner first outer diameter.

At step 330, the method includes applying to the liner, using the coil, a radial compression prestress to reduce the liner first outer diameter to a liner second outer diameter. The radial compression prestress compresses the liner to form a compacted liner that includes the liner second outer diameter. The liner second outer diameter may be smaller than the pipe inner diameter.

At step 340, the method includes removing the radial compression prestress thereby expanding the liner from the liner second outer diameter to form a surface-surface contact between the liner and a pipe inner diameter of a pipe. The liner and the coil may be disposed in the pipe inner diameter. The coil may be used to remove the radial compression prestress.

The method may include pressurizing the liner using a substance inside the liner to form a pressurized substance. The pressurized substance may permeate through the liner into a helical groove annulus formed between the helical groove and the pipe inner diameter. Permeating the pressurized substance through the liner wall (e.g., a liner thickness TR 404, FIG. 4) forms an annular pressurized substance in the helical groove annulus.

In accordance with one or more embodiments an example method includes the following steps. A first step may include applying an axial compression force to a coil to shorten the coil length from a relaxed length to an axially-compressed length, and to expand the coil diameter from a relaxed diameter to an expanded diameter. A second step may include inserting a liner inside of and coaxially with the internal diameter of the compressed coil. The liner may include at least one helical groove configured to cooperate with the coil to engage the coil with the liner, e.g., for a coil pitch to correspond with a helical groove pitch.

A third step may include relaxing the axial compression force thereby allowing a radial relaxing force provided by the coil diameter reverting from the expanded diameter to the relaxed diameter to apply a diameter-reducing radial force (a radial compression) to the liner. Provided that the liner OD is larger than the relaxed coil ID, then the reverting of the coil diameter from the expanded diameter to the relaxed diameter in turn includes applying to the liner a radial compression prestress. The radial compression prestress may reduce the liner outer diameter from a first outer diameter to a second outer diameter. The radial compression prestress may compress the liner to form a compacted liner that includes the liner second outer diameter. The liner second diameter may be smaller than the pipe inner diameter.

A fourth step may include moving the compressed coil system (e.g., the coil and the liner assembled together to inside the host pipe. A fifth step may include clamping the liner to the host pipe using one or more retention systems such as bonding with glue or molding (heat) or retention devices such as C-clamps. A sixth step may include removing the coil, which in turn allows the liner to expand the liner OD against the host pipe ID, thereby achieving a surface-surface contact between host pipe and liner.

### Liner Structure and Fitting Procedure

FIG. 4 shows a cylindrical polymer liner (e.g., a liner CPL 400) section of liner length Lr, (e.g., a liner first length LR 402), liner thickness Tr, (e.g., liner thickness TR 404), and liner outer diameter Dr, (e.g., a liner first outer diameter DR 406). The liner may be produced, for example, by extrusion. In an original or a relaxed state, the outer diameter (OD) Dr is larger than an internal diameter (ID) Dp (e.g., a pipe inner diameter DP 408), of a host pipe (e.g., a pipe P 410) section to be lined. The polymer liner section includes an external helical groove (e.g., a helix H 412) that has been molded, machined, or otherwise disposed on the outside diameter of the polymer liner.

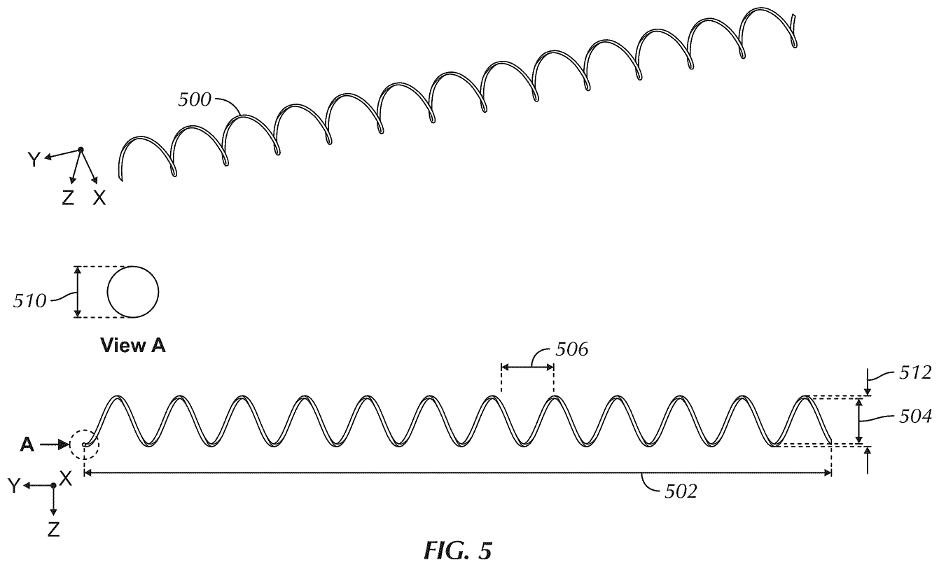

The helical groove includes a predetermined groove depth Dg, (e.g., a predetermined groove depth DG 414). Depending on design standards, minimum liner thickness (e.g., a minimum Tr) to avoid collapse may not include the thickness of the liner outside of the grooved area, i.e., the minimum Tr 404 may be measured from the liner inner wall to the bottom of the helical groove. The predetermined groove depth may be larger than a coil wire diameter (e.g., the coil wire diameter DSW 510, FIG. 5). The groove depth may vary along the length and/or circumference of the helix and/or liner. For example, the groove may have a first groove depth at a first location along the length and/or circumference of the liner, a second groove depth at a second location, a third groove depth at a third location, etc. A groove depth axis may correspond with an axis of the liner (e.g., a liner axis such as a liner OD axis or a liner ID axis) or the groove depth axis may be offset from the liner axis by an axis offset value x. The groove depth axis may vary from zero offset to x offset relative to the liner axis. The helical groove includes a specification for the groove that includes a groove pitch Pᵣ, (e.g., a helical groove pitch PR 416). Likewise, the groove pitch may vary along the length and/or circumference of the liner.

FIG. 4 shows a right-handed helix. Although the helix H 412 is described and shown as a right-handed helix, one of ordinary skill in the art will appreciate that the helix may be a left-handed helix, a double helix, a triple (or more than three) helix with congruent (first helix @ second helix) or incongruent helices, or any suitable shape or combination of shapes without departing from the scope of embodiments disclosed herein.

The pitch of the helix is the height of one complete helix turn, measured parallel to the axis of the helix. The double helix has two helices that may be on the same axis, differing by a translation along the axis. A triple helix has three helices. The three helices may differ by a first translation along the axis and a second translation along the axis.

FIG. 4 shows a cylindrical polymer liner section. Although the liner section is described and shown as a cylinder, one of ordinary skill in the art will appreciate that the cylinder may be a conical shape or any suitable shape or combination of shapes without departing from the scope of embodiments disclosed herein. A conical shape polymer liner may be considered an externally-tapered liner. A tapered liner first end of an externally-tapered liner may be slightly smaller than the internal diameter of the host pipe section to be lined. The externally tapered liner may ease installation of the tapered liner first end into the host pipe section.

In the case of the conical shape polymer liner (e.g., the externally-tapered liner), the helix will be in the form of a conic helix or conic spiral. A conic helix may be in the shape of a spiral on a conic surface. The distance to the apex may be an exponential function of the angle indicating direction from the axis. The helix groove includes a groove depth of the helix groove, and the groove depth may vary along the length and/or circumference of the helix and/or liner. The cross-sectional shape of the helix may include a flank, a crest, and a root analogous to a screw thread. The cross-sectional shape of the helix may be any suitable shape such as round (e.g., round profile R 413), oval, (e.g., oval profile O 426), square (e.g., square profile S 440), rectangular, (e.g., rectangular profile R 454), triangular, (e.g., triangular profile T 455), dovetail, (e.g., dovetail profile D 460), and other profiles (e.g., other profile P 472), etc. In this manner the walls of the groove may be flat, slanted, round, etc. The slanted helix walls may be any suitable angle such as forty-five degrees. The walls of the groove (e.g., groove wall W 420) may be engineered for the purpose of reacting against a normal force, (e.g., a normal force N 480). The groove walls may therefore have an isometry for an orientation such as a loaded or leading flank, (e.g., a leading flank L 422) and an unloaded or trailing flank, (e.g., a trailing flank T 424). In this manner the leading flank may be buttressed to react against the normal force.

FIG. 5 shows a helical coil in accordance with one or more embodiments. FIG. 5 shows a helical coil, for example a metallic spring-like metallic helical coil (e.g., a coil S 500). In its relaxed (stress-free) state, the coil has a length Lₛᵣ, (e.g., a coil first length LSR 502), a diameter Dₛᵣ, (e.g., a coil first inner diameter DSR 504), and a pitch Pₛᵣ, (e.g., a pitch PSR 506). The coil includes a coil wire diameter (e.g., a coil wire diameter DSW 510) and a coil outer diameter (e.g., a coil outer diameter DSO 512). The coil wire diameter may be smaller than the predetermined groove depth (e.g., the predetermined groove depth DG 414, FIG. 4).

In accordance with one or more embodiments Lₛᵣ is significantly greater than Lr (the liner first length LR 402, FIG. 4) to account for coil compression during installation. Although the coil is described and shown as a metallic coil, one of ordinary skill in the art will appreciate that the coil may be a phenolic material, a nonferrous material, a composite material, or any suitable material or combination of materials without departing from the scope of embodiments disclosed herein. Although the coil is described and shown as having a round cross section with a coil wire diameter, one of ordinary skill in the art will appreciate that the cross section may be a square shape, oval shape, or any suitable shape or combination of shapes without departing from the scope of embodiments disclosed herein. Likewise, the coil wire diameter may vary from a first coil wire diameter to a second and third, etc., wire diameters. Although the coil is described and shown as having a single outside diameter (the coil outer diameter DSO 512), one of ordinary skill in the art will appreciate that the coil may have an outside diameter that varies. For example, the coil outside wire diameter may vary from a first outside wire diameter to a second outside wire diameter, etc.

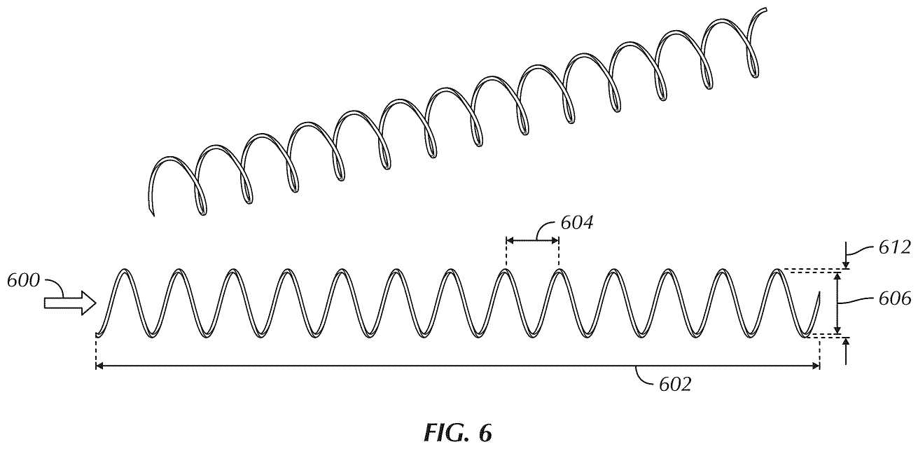

FIG. 6 shows a coil in accordance with one or more embodiments. FIG. 6 shows a coil that has been designed and manufactured in such a way that the compressed coil pitch corresponds to the helical groove pitch and the compressed coil inner diameter corresponds to the liner first outer diameter. When the coil is subjected to a predetermined axial compressing force Fc, (e.g., a compression force C 600) to form a compressed coil (e.g., a compressed coil length LC 602), its compressed coil pitch (e.g., a compressed coil pitch PR 604), becomes substantially equal to the helical groove pitch Pᵣ (e.g., the helical groove pitch PR 416, FIG. 4). When the coil is subjected to the compression force C 600, its compressed coil inner diameter (e.g., a coil second inner diameter C 606), becomes equal to (or slightly higher than) Dr, (e.g., the liner first outer diameter DR 406, FIG. 4) thereby forming a compacted liner. The compacted liner includes a second coil outer diameter (e.g., a coil second outer diameter DCSO 612).

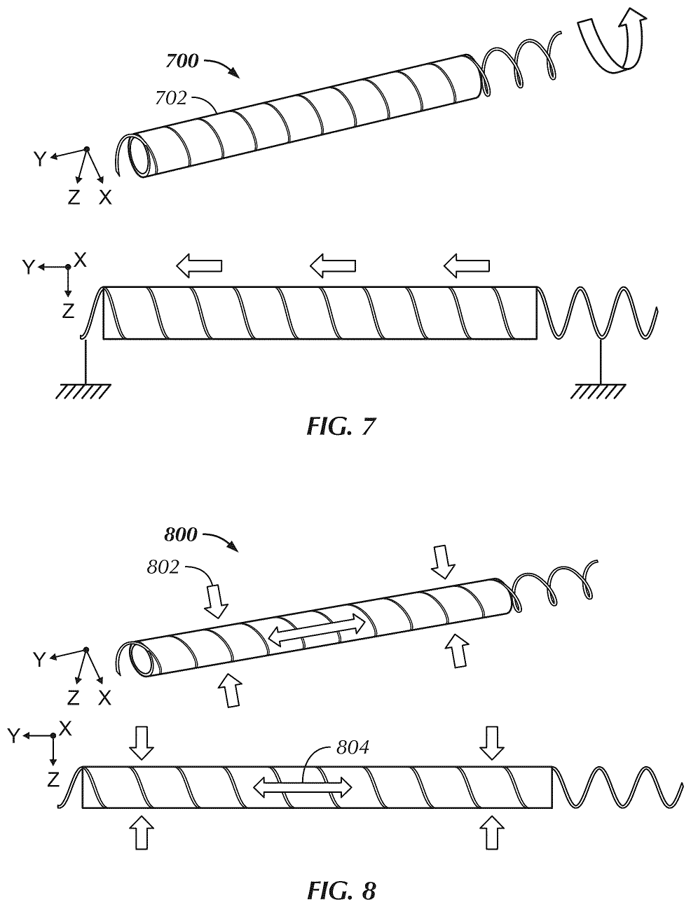

FIG. 7 shows a system in accordance with one or more embodiments. FIG. 7 shows a coil-liner assembly (e.g., a coil-liner assembly X 700 including an assembly of the coil and the liner). FIG. 7 shows that while the coil is isostatically maintained under compression, the liner is disposed in the compressed coil, i.e., the liner is inserted inside the coil through a combination of translational and/or rotational motion. The translation-rotation insertion may be facilitated by the coincident diameter and pitch dimensions of the liner and the coil under compression, i.e., by having the compressed coil inner diameter correspond with the liner first outer diameter, and by having the compressed coil pitch correspond with the helical groove pitch. In this manner the coil engages with the helix. Prior to inserting the liner inside the prestressed coil, a lubricant or other friction reducer (e.g., a friction reducer L 702) may be applied in the liner helical groove and/or on the coil. This lubricant may provide a benefit in the later phase when the coil is removed and separated from the liner.

FIG. 8 shows a system in accordance with one or more embodiments. FIG. 8 shows a compacted liner (e.g., a compacted liner X 800). FIG. 8 shows that the axial compression force that was previously exerted on the coil is progressively released, and the coil tends to return to (or close to) its initial (relaxed) diameter, length, and pitch, i.e., a coil axial extension occurs as the axial compression force is released. As the coil relaxes axially, the coil applies to the liner a radial compression prestress (e.g., radial compression prestress X 802) and an axial tension prestress (e.g., an axial tension prestress X 804). Although the liner will resist against the radial compression resulting from the coil radial compression, the liner will deform radially (a compression of the liner from a liner first outer diameter to form, e.g., a liner second outer diameter OD2 806). Likewise, although the liner will resist against the axial extension resulting from the coil axial tension, the liner will deform axially (an extension of the liner from a liner first length to form, e.g., a liner second length L2 808). The radial compression prestress reduces the liner first outer diameter to a liner second outer diameter to form a compacted liner (e.g., a compacted liner X 800). The coil stiffness is selected such that after stress relaxation on the coil, the diameter of the liner will converge to Dt, equal to the new coil diameter, and its length will become Lt. Example:

$${D}_{t} < {D}_{p} < {D}_{r} and {L}_{t} > {L}_{p} .$$

Additionally, the coil must be designed in such a way that the final load-balanced system (e.g., the assembly of the coil and the liner) does not cause permanent (plastic) deformations to the liner. The influential parameters to achieve the above conditions are the characteristic dimensions of the coil and of the liner.

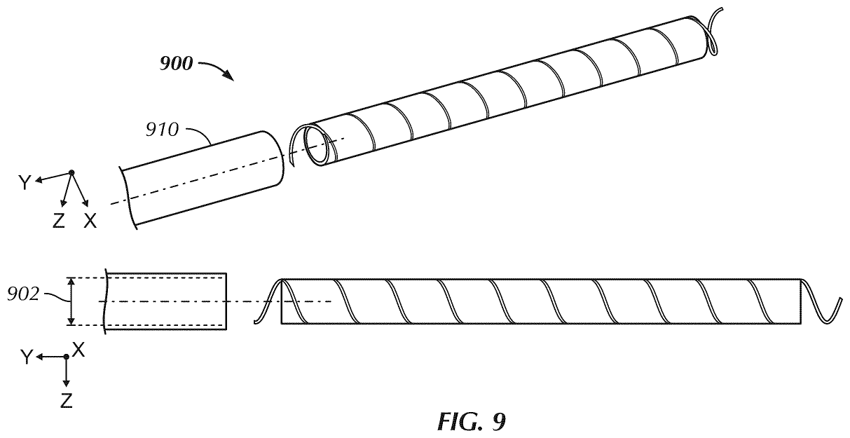

FIG. 9 shows a system in accordance with one or more embodiments. FIG. 9 shows a lined pipe system (e.g., a lined pipe system S 900) including the prestressed system (e.g., a compacted liner including a coil-liner assembly following coil relaxation) composed of the liner and the coil being inserted inside the host pipe section (e.g., a pipe P 910), i.e., inside the pipe inner diameter (e.g., a pipe inner diameter PID 902). The prestressed system includes a system OD that is smaller than the ID of the host pipe section. Typically, a difference of less than 5% between the two diameters will make insertion substantially without friction and compensates for typical manufacturing specification of ovality of the pipe section.

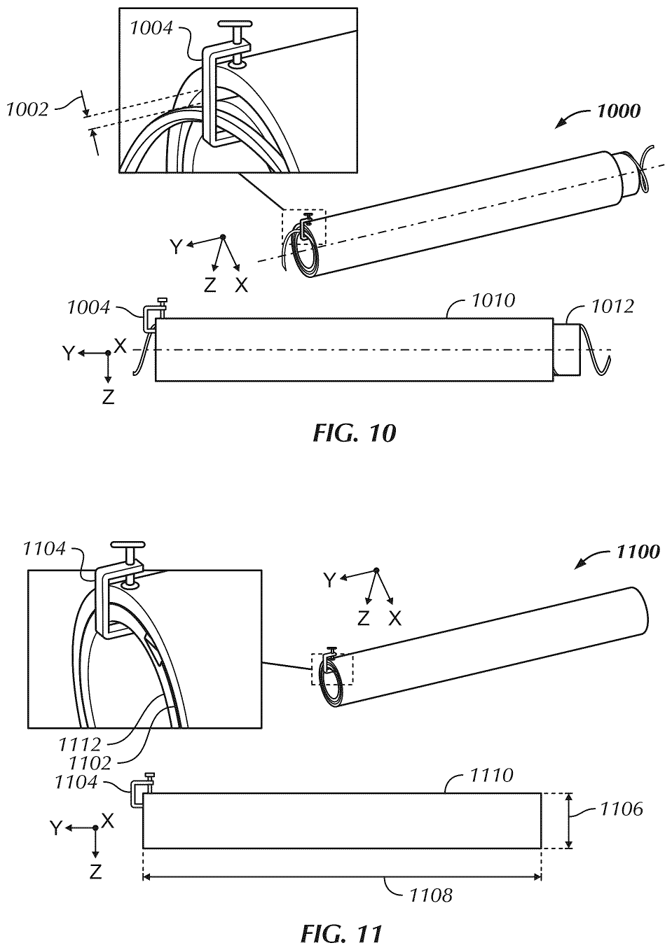

FIG. 10 shows a system in accordance with one or more embodiments. FIG. 10 shows a lined pipe system (e.g., a lined pipe system X 1000). FIG. 10 shows a compacted liner (e.g., a compacted liner X 1012) being installed in a pipe section (e.g., a pipe 1010). The prestressed coil-liner system (e.g., the compacted liner) is adjusted axially on one or both ends of the pipe section. FIG. 10 shows a gap (e.g., a gap G 1002) between the compacted liner and the inner wall of the pipe. A tool such as a C-clamp or other retention device or retention system (e.g., a clamp C 1004) may be used to maintain the liner in position at either end of the pipe section to prevent any further axial or rotational motion of the liner.

FIG. 11 shows a system in accordance with one or more embodiments. FIG. 11 shows a lined pipe system (e.g., a lined pipe system X 1100). FIG. 11 shows a compacted liner X 1112 inside a host pipe section (e.g., a pipe P 1110) and the liner are held together using a retention system (e.g., a clamp C 1104) to maintain the host pipe and the liner together while the coil is being removed.

The coil is removed (uncoiled) progressively from the system by application of a combined translation-rotation. For example, the coil may be removed using translation-rotation in the opposite directions in comparison with the translation-rotation directions applied as described in FIG. 7. The coil may be removed using translation-rotation in the same directions as described in FIG. 7. In this manner the coil is separated from the liner while the liner stays in the host pipe. In accordance with one or more embodiments the C-clamps may be used for clamping the liner to the host pipe to hold the liner in the host pipe as the coil is translated-rotated out between the liner and the host pipe This progressively relaxes the cylindrical polymer liner (e.g., the liner) radially to obtain a liner third outer diameter (e.g., a liner third diameter D3 1106) and axially to obtain a liner third length (e.g., a liner third length L3 1108). While the liner is relaxed radially, the elastic back spring effect of the liner will form a surface-surface contact (e.g., a contact X 1102) between the liner and the pipe inner diameter to ensure a tight-fit to the inner wall of the host pipe section. This operation has to be performed with care in order to avoid damaging the liner (e.g., liner twisting or tearing). Indeed, if the torque applied to the coil to cause rotation is too high, it can damage the liner. The presence of lubricant applied as described in FIG. 7 mitigates this risk and aims at decreasing the required torque (lower friction between the coil and the liner).

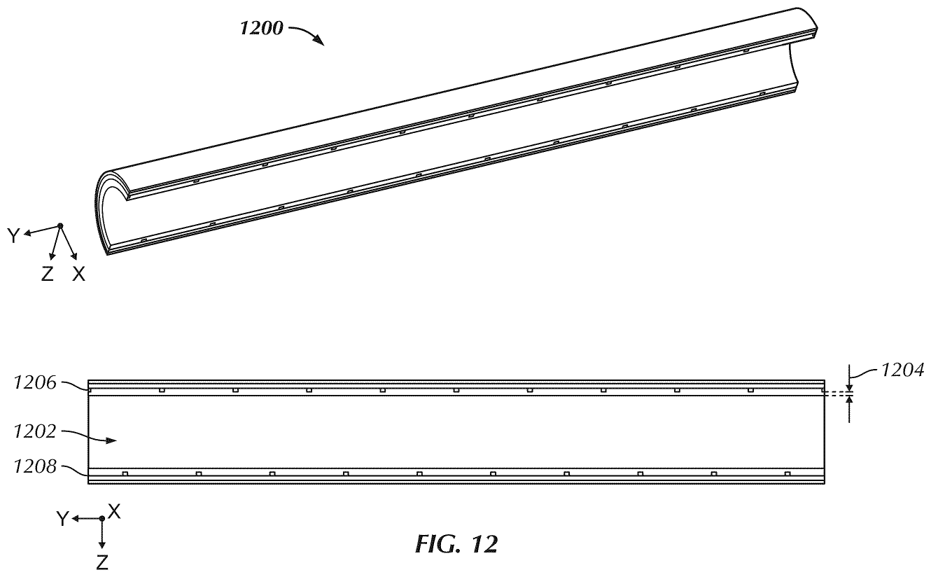

FIG. 12 shows the final state in which a liner fits tightly with a surface-surface contact to the pipe section and has the same length as the pipe section, thereby forming a lined pipe (e.g., a lined pipe S 1200). The lined pipe may be filled with a substance (e.g., a substance G 1202) such as water, oil, gas, sand, or other liquids, gases, or solids. The substance may be pressurized to form a pressurized substance. The pressurized substance may permeate through the liner wall with a liner thickness (e.g., a liner thickness TR 1204).

The helical grooves are spaces that can be either utilized in combination with a venting system to collect permeated substances, such as gases, permeating through the liner wall during service. The permeated substances may collect in an annular space such as a helical groove annulus (e.g., an annulus A 1206) formed by the external helical groove and the pipe inner diameter. Permeating the substance may form an annular pressurized substance in the helical groove annulus. The system and method may include depressurizing the annular pressurized substance using the external helical groove and a bleed-off port (e.g., a bleed-off port X 1208) coupled to the annulus and therefore to the external helical groove. The system and method may include depressurizing the cylindrical polymer liner (e.g., the liner). The helical grooves may be utilized to insert electrical or optical wiring to connect sensors. Alternatively, the grooves can be filled with polymer.

In some embodiments, the control system 126, the reservoir simulator 160, and/or a user device coupled to one of these systems may include a computer system that is similar to the computer system (e.g., computer 1302) described below with regard to FIG. 13 and the accompanying description. The control system 126 may predict the final load-balanced system of the coil and the liner does not cause permanent deformation to the liner. Inputs to the control system may include parameters regarding the intended use of the lined pipe. For example, the control system may use an input from the gas plant regarding the chemical properties, pressures, and temperature. Inputs to the control system may include parameters regarding dimensions of the coil and of the liner, such as groove-coil friction, and each of these parameters may include a sensitivity to temperature, humidity, and other factors.

The control system may use inputs provided by the user device and/or other control systems such as a process control system. The control system may then use an algorithm to determine liner parameters such as a first length LR, an external helical groove (e.g., a helix H), a helical groove pitch PR, and coil parameters such as a coil stiffness, coil first length LSR, a coil wire diameter DSW, coil outer diameter DSO, a compressed coil pitch PR, and coil second inner diameter C. The control system may use various deep learning, machine learning, and artificial intelligence technologies to predict the optimum parameters. For example, the control system may be trained using various liner materials, lengths, thicknesses, etc. and the resulting outcomes to make the predictions.

Embodiments may be implemented on a computer system. FIG. 13 is a block diagram of a computer system such as the computer 1302 used to provide computational functionalities associated with described algorithms, methods, functions, processes, flows, and procedures as described in the instant disclosure, according to an implementation. The illustrated computer (e.g., computer 1302) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 1302 may include a computer that includes an input device, such as a keypad, keyboard, touch screen, or other device that can accept user information, and an output device that conveys information associated with the operation of the computer 1302, including digital data, visual, or audio information (or a combination of information), or a graphical user interface.

The computer 1302 can serve in a role as a client, network component, a server, a database or other persistency, or any other component (or a combination of roles) of a computer system for performing the subject matter described in the instant disclosure. The illustrated computer (the computer 1302) is communicably coupled with a network 1316. In some implementations, one or more components of the computer 1302 may be configured to operate within environments, including cloud-computing-based, local, global, or other environment (or a combination of environments).

At a high level, the computer 1302 is an electronic computing device operable to receive, transmit, process, store, or manage data and information associated with the described subject matter. According to some implementations, the computer 1302 may also include or be communicably coupled with an application server, e-mail server, web server, caching server, streaming data server, business intelligence server, or other server (or a combination of servers).

The computer 1302 can receive requests over network 1316 from a client application (for example, executing on another computer 1302) and responding to the received requests by processing the said requests in an appropriate software application. In addition, requests may also be sent to the computer 1302 from internal users (for example, from a command console or by other appropriate access method), external or third-parties, other automated applications, as well as any other appropriate entities, individuals, systems, or computers.

Each of the components of the computer 1302 can communicate using a system bus 1304. In some implementations, any or all of the components of the computer 1302, both hardware or software (or a combination of hardware and software), may interface with each other or the interface 1306 (or a combination of both) over the system bus 1304 using an application programming interface (an API 1312) or a service layer 1314 (or a combination of the API 1312 and service layer 1314. The API 1312 may include specifications for routines, data structures, and object classes. The API 1312 may be either computer-language independent or dependent and refer to a complete interface, a single function, or even a set of APIs. The service layer 1314 provides software services to the computer 1302 or other components (whether or not illustrated) that are communicably coupled to the computer 1302. The functionality of the computer 1302 may be accessible for all service consumers using this service layer. Software services, such as those provided by the service layer 1314, provide reusable, defined business functionalities through a defined interface. For example, the interface may be software written in JAVA, C++, or other suitable language providing data in extensible markup language (XML) format or other suitable format. While illustrated as an integrated component of the computer 1302, alternative implementations may illustrate the API 1312 or the service layer 1314 as stand-alone components in relation to other components of the computer 1302 or other components (whether or not illustrated) that are communicably coupled to the computer 1302. Moreover, any or all parts of the API 1312 or the service layer 1314 may be implemented as child or sub-modules of another software module, enterprise application, or hardware module without departing from the scope of this disclosure.

The computer 1302 includes an interface 1306. Although illustrated as a single interface in FIG. 13, two or more of the interfaces may be used according to particular needs, desires, or particular implementations of the computer 1302. The interface 1306 is used by the computer 1302 for communicating with other systems in a distributed environment that are connected to the network 1316. Generally, the interface 1306 includes logic encoded in software or hardware (or a combination of software and hardware) and operable to communicate with the network 1316. More specifically, the interface 1306 may include software supporting one or more communication protocols associated with communications such that the network 1316 or hardware of the interface is operable to communicate physical signals within and outside of the illustrated computer (computer 1302).

The computer 1302 includes at least one of a computer processor 1318. Although illustrated as a single computer processor in FIG. 13, two or more processors may be used according to particular needs, desires, or particular implementations of the computer 1302. Generally, the computer processor 1318 executes instructions and manipulates data to perform the operations of the computer 1302 and any algorithms, methods, functions, processes, flows, and procedures as described in the instant disclosure.

The computer 1302 also includes a memory 1308 that holds data for the computer 1302 or other components (or a combination of both) that can be connected to the network 1316. For example, memory 1308 can be a database storing data consistent with this disclosure. Although illustrated as a single memory in FIG. 13, two or more memories may be used according to particular needs, desires, or particular implementations of the computer 1302 and the described functionality. While memory 1308 is illustrated as an integral component of the computer 1302, in alternative implementations, memory 1308 can be external to the computer 1302.

The application 1310 is an algorithmic software engine providing functionality according to particular needs, desires, or particular implementations of the computer 1302, particularly with respect to functionality described in this disclosure. For example, application 1310 can serve as one or more components, modules, applications, etc. Further, although illustrated as a single one of application 1310, the application 1310 may be implemented as a multiple quantity of application 1310 on the computer 1302. In addition, although illustrated as integral to the computer 1302, in alternative implementations, the application 1310 can be external to the computer 1302.

There may be any number of computers such as the computer 1302 associated with, or external to, a computer system containing computer 1302, each computer 1302 communicating over network 1316. Further, the term “client,” “user,” and other appropriate terminology may be used interchangeably as appropriate without departing from the scope of this disclosure. Moreover, this disclosure contemplates that many users may use one of computer 1302, or that one user may use multiple computers such as computer 1302.

In some embodiments, the computer 1302 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile backend as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed is:

1. A method comprising:
providing a liner comprising a liner first outer diameter;
disposing the liner inside a coil;
applying to the liner, using the coil, a radial compression prestress to reduce the liner first outer diameter to a liner second outer diameter; and
removing the radial compression prestress thereby expanding the liner from the liner second outer diameter to form a surface-surface contact between the liner and a pipe inner diameter of a pipe.

2. The method of claim 1, wherein:
the liner comprises an external helical groove on the liner first outer diameter; and
the external helical groove comprises a helical groove pitch corresponding to a compressed coil pitch.

3. The method of claim 1, wherein:
the liner first outer diameter is larger than the pipe inner diameter.

4. The method of claim 1, further comprising:
compressing, using a predetermined axial compressing force, the coil comprising a coil first inner diameter, to form a compressed coil comprising a coil second inner diameter; and
wherein the coil first inner diameter is smaller than the liner first outer diameter;
wherein the coil second inner diameter is larger than the liner first outer diameter.

5. The method of claim 1, further comprising:
reducing, using a friction reducer, a friction between the coil and the liner.

6. The method of claim 1, wherein:
compressing, using the radial compression prestress, the liner to form a compacted liner comprising the liner second outer diameter, wherein the liner second outer diameter is smaller than the pipe inner diameter.

7. The method of claim 1, further comprising:
disposing the liner in the pipe inner diameter; and
removing, using the coil, the radial compression prestress to obtain a liner third outer diameter.

8. The method of claim 1, further comprising:
pressurizing the liner using a substance inside the liner to form a pressurized substance; and
permeating the pressurized substance through a liner thickness into a helical groove annulus;
wherein the permeating the pressurized substance forms an annular pressurized substance in the helical groove annulus.

9. The method of claim 8, further comprising:
depressurizing the annular pressurized substance using a bleed-off port.

10. The method of claim 8, further comprising:
depressurizing the substance from the liner.

11. A system, comprising:
a liner, comprising a liner first outer diameter, disposed in a coil;
wherein the coil is configured to apply to the liner a radial compression prestress to reduce the liner first outer diameter to a liner second outer diameter; and
a pipe comprising a pipe inner diameter;
wherein removing the radial compression prestress expands the liner from the liner second outer diameter to form a surface-surface contact between the liner and the pipe inner diameter.

12. The system of claim 11, wherein:
the liner comprises an external helical groove on the liner first outer diameter; and
the external helical groove comprises a helical groove pitch corresponding to a compressed coil pitch.

13. The system of claim 11, wherein:
the liner first outer diameter is larger than the pipe inner diameter.

14. The system of claim 11, wherein:
the coil comprises a coil first inner diameter;
the coil is configured to be compressed, using a predetermined axial compressing force, to form a compressed coil comprising a coil second inner diameter; and
wherein the coil first inner diameter is smaller than the liner first outer diameter;
wherein the coil second inner diameter is larger than the liner first outer diameter.

15. The system of claim 11, further comprising:
a friction reducer configured for reducing a friction between the coil and the liner.

16. The system of claim 11, wherein:
the radial compression prestress compresses the liner to form a compacted liner comprising the liner second outer diameter, wherein the liner second outer diameter is smaller than the pipe inner diameter.

17. The system of claim 11, wherein:
the coil is configured for removing the radial compression prestress of the liner in the pipe inner diameter to obtain a liner third outer diameter.

18. The system of claim 11, further comprising:
a substance inside the liner configured for pressurizing the liner to form a pressurized substance; and
wherein the pressurized substance permeates through a liner thickness into a helical groove annulus;
wherein the permeating the pressurized substance forms an annular pressurized substance in the helical groove annulus.

19. The system of claim 18, further comprising:
a bleed-off port configured for depressurizing the annular pressurized substance.

20. The system of claim 18, wherein:
the substance is configured for depressurizing from the liner.

21. The method of claim 1, wherein:
the liner first outer diameter comprises a predetermined groove depth;
wherein the predetermined groove depth is larger than a coil wire diameter.

22. The method of claim 2:
wherein the liner further comprises a liner first length; and
the method further comprises:
applying to the liner, using the coil, an axial tension prestress to change the liner from the liner first length to a liner second length; and
removing the axial tension prestress thereby changing the liner from the liner second length to a liner third length.

23. The method of claim 22, wherein:
applying the axial tension prestress further comprises engaging the coil in the external helical groove; and
removing the axial tension prestress further comprises uncoiling the coil from the external helical groove.

24. The method of claim 2, wherein:
applying the radial compression prestress further comprises engaging the coil in the external helical groove; and
removing the radial compression prestress further comprises uncoiling the coil from the external helical groove.

25. The system of claim 11, further comprising:
a predetermined groove depth disposed on the liner first outer diameter; and
a coil wire diameter wherein the predetermined groove depth is larger than the coil wire diameter.

26. The system of claim 12, further comprising:
a liner first length of the liner; and
wherein the coil is configured to apply to the liner an axial tension prestress to elongate the liner from the liner first length to a liner second length;
wherein removing the axial tension prestress changes the liner from the liner second length to a liner third length.

27. The system of claim 26, wherein:
applying the axial tension prestress further comprises engaging the coil in the external helical groove; and
removing the axial tension prestress further comprises uncoiling the coil from the external helical groove.

28. The system of claim 12, wherein:
applying the radial compression prestress further comprises engaging the coil in the external helical groove; and
removing the radial compression prestress further comprises uncoiling the coil from the external helical groove.
